(19) United States
(12) Patent Application Publication
(10) Pub. No.: US 2002/0065861 A1
(43) Pub. Date: May 30, 2002

(54) Table lookup based phase calculator for high-speed communication using normalization of input operands

(76) Inventors: Ki Seon Kim, Kwangju (KR); Seung Geun Kim, Kwangju (KR)

Correspondence Address: BACON & THOMAS, PLLC, 4th Floor, 625 Slaters Lane, Alexandria, VA, 22314-1176, US

(21) Appl. No.: 09/767,913

(22) Filed: Jan. 24, 2001

(30) Foreign Application Priority Data
Sep. 27, 2000 (KR) 10-2000-56787

(51) Int. Cl. G06F 1/02

(52) U.S. Cl. 708/270; 708/276

(57) ABSTRACT

Disclosed is a table lookup based phase calculator for a high-speed communication using normalization of input operands which can reduce the size of a phase table by converting respective input data into a sign and a magnitude, respectively, normalizing the magnitude of converted signals within a predetermined range, and reading the phase table using only upper L bits of the normalized input data. The phase calculator includes two absolute value operation units for calculating a magnitude of input data represented in a 2's complement, a normalization factor operation unit for calculating an amount of shift left by calculating leading zeros, a variable shifting unit for performing a shift left operation as much as a normalization factor determined by the normalization factor operation unit, an address generating unit for generating a lookup address of a phase table using only upper L bits of the two normalized input data, an arctan storage unit for storing pre-calculated arctan values according to the lookup address of the phase table, and a phase expanding unit for converting a phase value between 0 and π/2 into a phase value between −π and π.

### BACKGROUND OF THE INVENTION

1. Field of the Invention

The present invention relates to a table lookup based phase calculator for a high-speed communication using normalization of input operands. In particular, the present invention relates to the technique of implementing an arctan function block using a table lookup system in a digital communication system.

2. Description of the Related Art

In order to implement a digital communication system, it is required to calculate a phase signal from I/Q channel data. At this time, a function block expressed by an arctan function is used, and this function is expressed by the following equation.

$$θ = arctan \{ \frac{{ⅆ}_{Ich}}{{ⅆ}_{Qch}} \} \qquad [ Equation 1 ]$$

Here, d_{Ich} is I-channel data, and d_{Qch} is Q-channel data.

The arctan function block can be implemented using a coordinate rotation digital computer (CORDIC) algorithm or a table lookup function.

FIG. 1 is a block diagram illustrating an input/output relation in the conventional arctan function block.

According to the input/output relation in the top level illustrated in FIG. 1, the N-bit I-channel data d_{Ich}(1) and the N-bit Q-channel data d_{Qch}(3) are used as input operands of the arctan function block 5, and an M-bit phase θ (7) is outputted from the block 5.

In order to make an M-bit phase table using all input data, a table having the size of 2^{2N}×M-bit is required. As the size of N increases one at a time, a required size of the phase table exponentially increases 4 times at a time. As the size of M increases one at a time, the size of the phase table linearly increases 2^{2N} at a time.

Also, as the size of the table increases, it takes a longer time to read values from the table, and it becomes difficult to implement the table. Thus, for a high-speed operation and easiness of implementation, the size of the lookup table should be reduced as much as possible.

As shown in the equation 1, it can be recognized that the operation of the arctan function block is a function of the ratio of d_{Ich}(1) and d_{Qch}(3).

Accordingly, leading zeros (in case of a minus in a 2's complement representation, leading one) commonly exist in d_{Ich}(1) and d_{Qch}(3) are detected, and normalized by performing a shift left operation on the input data as much as the number of the common leading zeros.

At this time, since the ratio of the I-channel data to the Q-channel data is not changed even if the detection and normalization of the leading zeros have been performed, the arctan operation produces the same result, but the size of the phase table can be reduced to ¾.

Also, the input data d_{Ich}(1) and d_{Qch}(3) are converted into a sign and a magnitude, respectively, a phase between 0 and π/2 is obtained using the magnitude of the input data, and then the phase is expanded between −π and π using the signs of the input data. Using this method, only the phases between 0 and π/2 are stored in the table, and thus the size of the phase table can be reduced to ¼.

As described above, if both the two methods as above are simultaneously used, the size of the phase table can be reduced to 3/16. However, in consideration of the magnitude of the input signal generally used, the size of the phase table is still too large, and this causes trouble in area and speed.

### SUMMARY OF THE INVENTION

Therefore, the object of the present invention is to solve the problems involved in the related art, and to provide a table lookup based phase calculator for a high-speed communication using the normalization of input operands which can reduce the size of a phase table by converting respective input data into a sign and a magnitude, respectively, normalizing the magnitude of converted signals within a predetermined range, and reading the phase table using only upper L bits of the normalized input data.

In accordance with the present invention, the above object is accomplished by providing a table lookup based phase calculator for a high-speed communication using normalization of input operands which 1) obtains a magnitude of input data by performing an absolute value operation for obtaining an absolute value of the input data, and then detects leading zeros from a normalization factor determiner; 2) normalizes two signals expressed by (N−1) bits within a predetermined range, not for all the range, when determining a normalization factor using the fact that it is not required to calculate an exactly accurate arctan value with respect to the input data combination since if the magnitude of the input data is small, only a noise exists, or the data is not a sample for determining desired received data; 3) normalizes the magnitude of the input data by performing a shift left operation as much as the number of the leading zeros determined by the normalization factor determiner, and generates a 2L-bit table lookup address using respective upper L bits of the input data; 4) obtains a (M−2)-bit phase between 0 and π/2 with reference to the 2L-bit table address; and 5) converts the phase between 0 and π/2 into a phase between −π and π using the phase existing between 0 and π/2 with reference to the table and the signs of the input data, and outputs an M-bit phase; whereby the size of the table is reduced to 2^{2L}×(M−2), and an effect exerted on a performance of a whole communication system is minimized.

### BRIEF DESCRIPTION OF THE DRAWINGS

The above object, and other features and advantages of the present invention will become more apparent after a reading of the following detailed description when taken in conjunction with the drawings, in which:

FIG. 1 is a block diagram illustrating an input/output relation in the conventional arctan function block;

FIG. 2 is a block diagram of an arctan function operator block for converting I/Q-channel data into a phase according to the present invention;

FIG. 3 is a circuit diagram illustrating the construction of a gate-level absolute value calculator according to the present invention;

FIG. 4 is a view illustrating an operation algorithm of a normalization factor calculator with respect to an 8-bit input according to the present invention;

FIG. 5 is a block diagram of a phase expander according to the present invention;

FIG. 6 is a block diagram of a phase expander of another type according to the present invention; and

FIG. 7 is a block diagram of a phase expander optimized in a gate level according to the present invention.

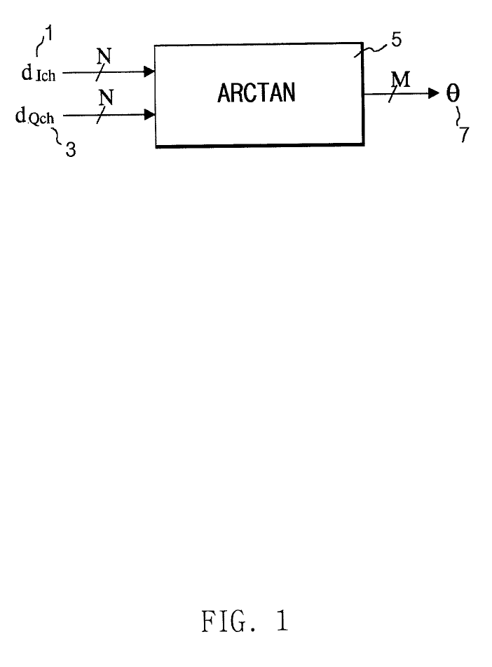

### DETAILED DESCRIPTION OF THE PREFERRED EMBODIMENTS

The construction and operation of the embodiments of the present invention will be explained with reference to the accompanying drawings.

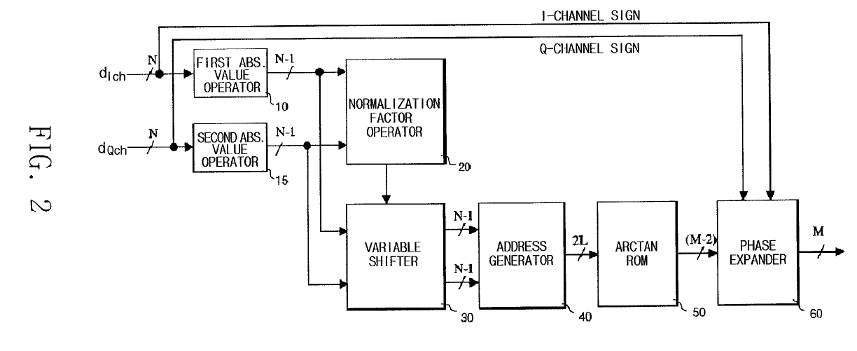

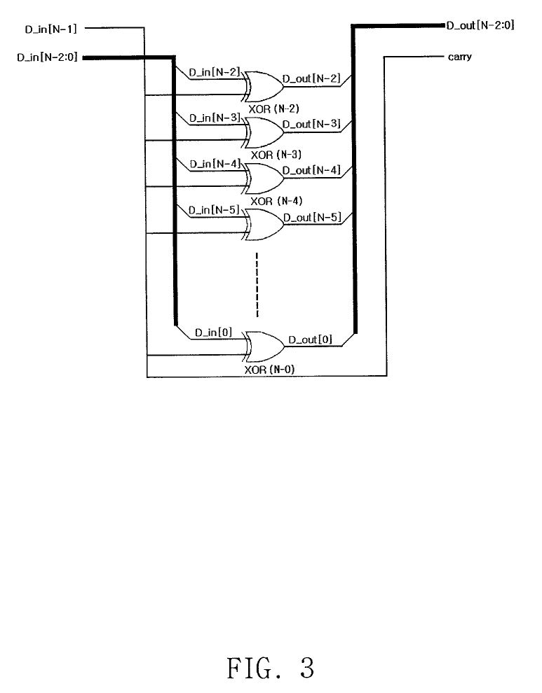

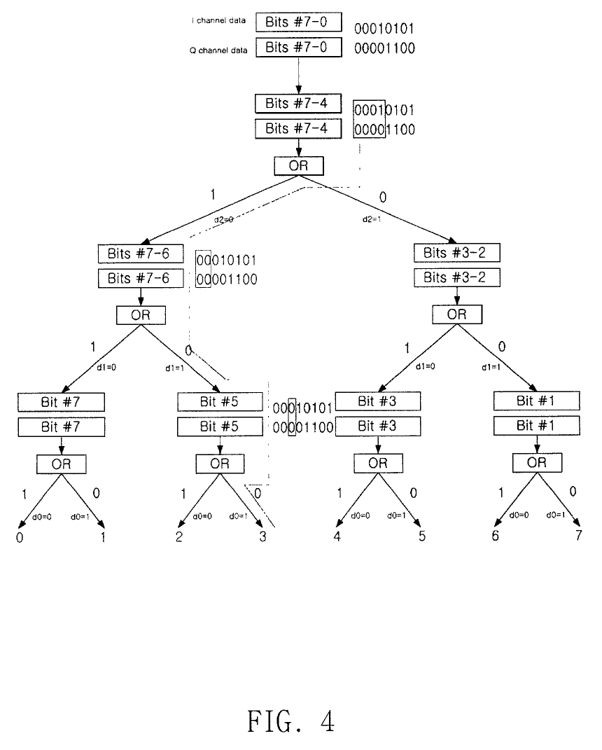

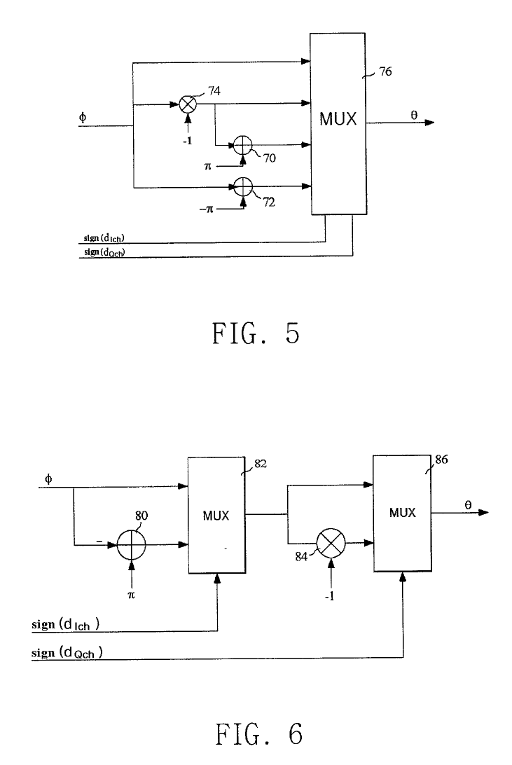

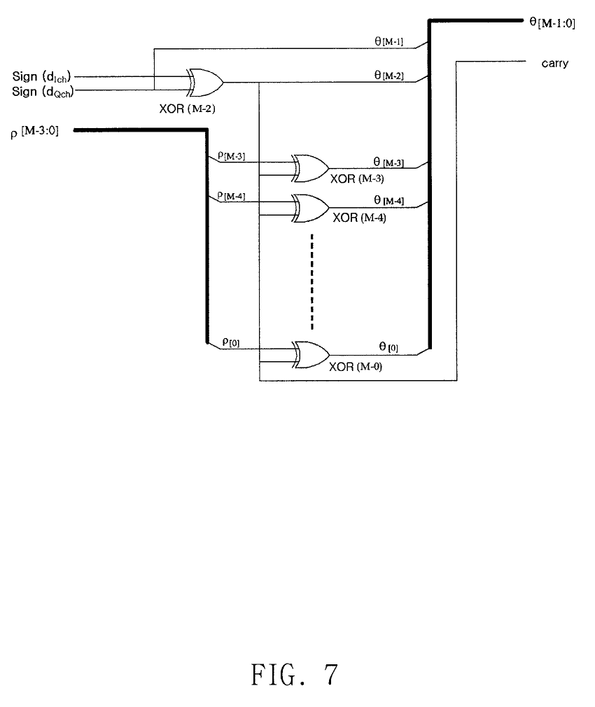

FIG. 2 is a block diagram of an arctan function operator block for converting I/Q-channel data into a phase according to the present invention. FIG. 3 is a circuit diagram illustrating the construction of a gate-level absolute value calculator according to the present invention, and FIG. 4 is a view illustrating an operation algorithm of a normalization factor calculator with respect to an 8-bit input according to the present invention. FIG. 5 is a block diagram of a phase expander according to the present invention, FIG. 6 is a block diagram of a phase expander of another type according to the present invention, and FIG. 7 is a block diagram of a phase expander optimized in a gate level according to the present invention.

Referring to FIG. 2, the arctan function operator block comprises first and second absolute value operators 10 and 15 for calculating a magnitude of input data represented in 2's complement format, a normalization factor operator 20 for calculating the amount of shift left by calculating leading zeros, a variable shifter 30 for performing a shift left operation as much as a normalization factor determined by the normalization factor operator 20, an address generator 40 for generating a lookup address of a phase table using only upper L bits of the normalized data, an arctan read only memory (ROM) 50 for storing the phase table, and a phase expander 60 for converting a phase value between 0 and π/2 into a phase value between −π and π.

Since d_{Ich}(1) and d_{Qch}(3), which are inputs of the first and second absolute value operators 10 and 15, are values represented in 2's complement format, they may be plus or minus numbers, and thus the sign combination of two input data may be four cases.

That is, the sign combination is classified into a case that both of them are plus, a case that both of them are minus, and a case that one of them is plus and the other is minus. Since it merely increases the complexity of implementation to consider all the four cases of sign combination, the internal operation is performed using only the magnitude of the input data, and then the phase calculated in consideration of the sign of the input data 1 and 3 by the phase expander 60 is converted into a resultant phase as described above.

The first and the second absolute value operators 10 and 15 perform the operation of obtaining the magnitude of the input data that is represented in 2's complement. If the N-bit input data is a plus, the most significant bit (MSB) becomes 0, and the (N−1)-bit input data excluding the MSB becomes the magnitude of the input data.

Also, if the input data is a minus, the MSB of the input data becomes 1, and the 2's complement of the (N−1)-bit input data excluding the MSB becomes the magnitude of the input data.

Accordingly, if the input data is a plus (i.e., MSB=0), the remaining lower (N−1) bits represent the magnitude of the input data, and thus the lower (N−1) bits are used as the magnitude of the input data as they are. However, if the input data is a minus (i.e., MSB=1), the 2's complement of the lower (N−1) bits corresponds to the magnitude of the input data.

The operation process of obtaining a 2's complement is performed in a manner that a 1's complement is first obtained, and 1 is added to a least significant bit (LSB).

According to the present invention, in case that the input data is a minus, the magnitude of the input data is not obtained by taking a 2's complement, but is obtained by taking a 1's complement, and then adding 1 to the LSB through the following operation. Accordingly, an adder for adding 1 to the LSB can be removed, and thus a small area and high-speed operation can be achieved.

According to the construction of the first and the second absolute value calculators 10 and 15 as shown in FIG. 3, a D_in[N−1] terminal and D_in[N−2:0] are connected to a D_out[N−2:0] through XOR(N−2) to XOR(N−0) to obtain a 2's complement, and a D_in[N−1] is directly connected to a carry to obtain a value to be added to the LSB through the following operation.

That is, the 1's complement is obtained by the XOR operation of the MSB of the input data and the lower (N−1) bits, and the MSB is outputted as a carry signal.

Specifically, if the input data is a plus (i.e., MSB=0), the lower (N−1) bits are outputted as they are by the XOR operation and the carry signal becomes 0. If the input data is a minus (i.e., MSB=1), the lower (N−1) bits are outputted as a 1's complement, and the carry signal becomes 1, so that a 2's complement can be obtained through the following operation.

Thereafter, the normalization factor operator 20 of the arctan operator block 5 searches the number of leading zeros using only the (N−1)-bit D_out among the outputs of the absolute value operators 10 and 15. In this case, if the signal is a minus, the magnitude of the signal becomes a value smaller than the actual magnitude as much as the magnitude of the LSB.

However, since this value is smaller than an error produced by the noise on the channel and the cutting by the table address generator, it may be ignored.

The basic operation of the normalization factor operator 20 is to search a position where a bit that is not 0 first appears from the MSB of the two (N−1)-bit inputs, and to express it with p(=┌log₂(N−1)1┐) bits. Here, ┌x┐ is a minimum natural number that is not smaller than x.

The position where a bit that is not 0 first appears from the MSB is represented as S(=Sₚ₋₁Sₚ₋₂ . . . S₀). The operation for searching the leading zeros in common from the two (N−1)-bit inputs can be performed using an OR-operation.

Specifically, the OR-operation is performed with respect to the two inputs, and then 0s until the bit where 1 first appears, starting from the MSB, are counted. A generally used normalization factor calculator observes all the (N−1)-bit inputs, and calculates the normalization factor.

For an easy explanation, it is assumed that the size of the input bits, i.e., (N−1) is a power of 2. However, in case that (N−1) is not the power of 2, the common leading zeros can be searched using the same method.

First, the MSB(Sₚ₋₁) of S is calculated. That is, if the results of OR-operation of upper 2^{p-1} bits of the two inputs are all 0, it means that the first bit that is not 0 among the two inputs exists lower than the upper 2^{p-1} bits, and thus the MSB of S is determined to be 1.

On the contrary, if the results of OR-operation of upper 2^{p-1} bits of the two inputs are not all 0, it means that the bit that is not 0 exists within the upper 2^{p-1} bits, and thus the MSB is determined to be 0. Whether the results of OR-operation of the observed 2^{p-2} bits of the two inputs are all 0 or not, the Sₚ₋₂ is determined in the same manner as Sₚ₋₁.

However, the observed 2^{p-2} bits are determined according to Sₚ₋₁, determined as above. If Sₚ₋₁ is 0, the upper 2^{p-2} bits are observed. If Sₚ₋₁ is 1, upper 2^{p-2} bits that follow the upper 2^{p-1} bits are observed. By repeating the above process p times, S is determined.

As an embodiment of the present invention, calculation of the normalization factor with respect to an 8-bit input combination using an operation algorithm of the normalization factor calculator as described above is illustrated in FIG. 4.

However, according to the present invention, the normalization factor is calculated by observing the upper (N−1-L) bits among the (N−1) bits since the table address generator 40 generates the table lookup address using the respective upper L bits after normalization. The normalization factor operation is performed by the algorithm illustrated in FIG. 4.

Then, the variable shifter 30 of the arctan operator block performs the shift left operation as much as the common leading zeros calculated by the phase shift calculator. The lookup address of the 2L-bit arctan ROM 50 is generated by gathering the upper L bits of the outputs of the two variable shifters 30 from which the common leading zeros are removed.

Specifically, the upper L bits of the magnitude of the normalized d_{Ich} correspond to the upper L-bit portion of the 2L bits that is the lookup address of the arctan ROM 50, and the upper L bits of the magnitude of the normalized d_{Qch} correspond to the lower L-bit portion. In the table of the arctan ROM 50 corresponding to the 2L-bit address are stored the arctan values calculated by the combination of the normalized I/Q data.

In the respective lookup address of the arctan ROM 50 is stored a corresponding value obtained by quantizing with (M−2) bits the phase value calculated according to the ratio of the normalized two input values which are combined in the address generator 40. The inputs of the address generator 40 are the data having passed the first and the second absolute value calculators 10 and 15, and thus are all the plus numbers.

At this time, since all the calculated phase values exist in the first quarter, only the phase values between 0 and π/2 quantized into integers are stored in the table of the arctan ROM 50.

Thereafter, the phase expander 60 of the arctan operator block converts the input phase between 0 and π/2 into the phase between −π and π using the signs of the input data and the input phase which was calculated through the previous operation blocks using only the magnitudes of the input data.

If the phase obtained using only the magnitude of the input data is ψ, then ψ exists in the region of (0,π/2) . If the phase obtained using all the magnitude and the sign of the input data is represented as θ, the relation between ψ and θ is given in Table 1 as below.

TABLE 1

| Sing (d_{Ich}) | sign (d_{Qch}) | θ |
|---|---|---|
| Plus | Plus | Ψ |
| Minus | Plus | π −Ψ |
| Minus | Minus | −π +Ψ |
| Plus | Minus | −Ψ |

If the MSB of x is 0, the sign(x) is plus, and if the MSB of x is 1, the sign(x) is minus.

FIG. 5 is a block diagram of a phase expander according to the present invention that directly uses the above conversion relation. Referring to FIG. 5, the phase expander includes two adders 70 and 72, a multiplier 74, and a multiplexer 76 connected to the adders and the multiplier.

Specifically, if the sign of d_{Ich} is a plus, the resultant phase is expressed by a function of only ψ, but if the sign of d_{Ich} is a minus, the resultant phase is expressed by a function of ψ and π.

Accordingly, the sign of d_{Ich} determines which ψ or ψ−π is used. If the sign of d_{Qch} is plus, the phase determined by the sign of d_{Ich} is used as a resultant phase, while if the sign of d_{Qch} is minus, the determined phase multiplied by −1 is used as a resultant phase.

FIG. 6 is a block diagram of a phase expander of another type according to the present invention. In the phase expander, an adder 80 is connected to a first multiplexer (MUX) 82, and a multiplier 84 is connected to a second multiplexer (MUX) 86. The phase expander of FIG. 6 performs the same function of the phase expander of FIG. 5 with its construction simplified in comparison to that of the phase expander of FIG. 5.

Now, the method of obtaining the phase quantized into an M-bit integer using the (M−2)-bit phase, which is quantized into an integer and is an output of the table of the arctan ROM 50, and the sign of the input data will be explained.

If it is assumed that the table output of the arctan ROM 50 is ρ that is expressed as an (M−2)-bit integer, the 2's complement of ρ is indicated as \overline{ρ}, and the respective bits of ρ and \overline{ρ} are indicated as ρ_{M-3}ρ_{M-4} . . . ρ₀ and \overline{ρ_{M-3}ρ_{M-4} . . . ρ₀}, respectively.

Also, if the resultant phase is θ, the respective bit is indicated as θ_{M-1}θ_{M-2} . . . θ₀. In case of phase expansion by the sign of d_{Ich} and the sign of d_{Qch}, the relation between ρ and θ is shown in Table 2.

TABLE 2

| Sign (d_{Ich}) | sign (d_{Qch}) | θ _{M-1} | θ _{M-2} | θ _{M-3} . . . θ ₀ |
|---|---|---|---|---|
| 0 | 0 | 0 | 0 | ρ |
| 1 | 0 | 0 | 1 | \overline{ρ} |
| 1 | 1 | 1 | 0 | ρ |
| 0 | 1 | 1 | 1 | \overline{ρ} |

Using the above relation, the phase quantized into an integer can be easily expanded.

At this time, in implementing the 2's complement of ρ, the 1's complement of ρ is produced by directly applying the principle explained with reference to the absolute value calculator of FIG. 3, and then 1 is added to the LSB through the following operation process to perform a high-speed operation. The addition of 1 to the LSB may be ignored according to the function of the following stage.

Accordingly, the phase quantized into an integer can be easily expanded by applying the same method to a phase expander optimized in a gate level as illustrated in FIG. 7.

Specifically, in the phase expander of FIG. 7, the sign(d_{Qch}) terminal is connected to the θ[M−1] terminal, and the sign(d_{Ich}) terminal and the sign(d_{Qch}) are connected to the θ[M−2] terminal and the carry through the XOR(M−2) . It is determined whether to take the 1's complement of ρ[M−3:0] when a ρ[M−3:0] terminal corresponds to θ[M−3:0] through XOR(M−3) to XOR(M−0) according to the operation result of the XOR(M−2).

As described above, the table lookup based phase calculator for a high-speed communication using normalization of input operands has the following advantages.

First, the effect exerted on the performance of the whole communication system can be minimized with the size of the phase lookup table reduced from 2^{2N}×M to 2^{2L}×(M−2).

Second, in order to use a reduced table, an additional operation time is required for pre/post-processing i.e. removing the common zeros and phase expansion. However, as the size of the table becomes smaller, the time for the table lookup becomes shorter.

Accordingly, in case that the additional operation time causes any problem, a pipe line structure between the pre/post-processing blocks and the lookup table may be designed to overcome the problem.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A table lookup based phase calculator for a high-speed communication using a normalization of input operands, comprising:
first and second absolute value operation unit for calculating a magnitude of input data represented in 2's complement format;
a normalization factor operation unit for calculating an amount of shift left by calculating leading zeros;
a variable shifting unit for performing a shift left operation as much as a normalization factor determined by the normalization factor operation unit;
an address generating unit for generating a lookup address of a phase table using only upper L bits of the two normalized input data;
an arctan storage unit for storing pre-calculated arctan values according to the lookup address of the phase table; and a phase expanding unit for converting a phase value between 0 and π/2 into a phase value between −π and π.

2. The phase calculator as claimed in claim 1, wherein the first and the second absolute value operation units take the 1's complement of the magnitude of the input data and then generate a carry signal so that 1 is added to LSB through a following operation in case that the input data is a minus.

3. The phase calculator as claimed in claim 1, wherein the normalization factor calculating unit searches the number of leading zeros using only two (N−1)-bit D_out signals among outputs of the first and the second absolute value operation units.

4. The phase calculator as claimed in claim 1, wherein the normalization factor calculating unit calculates the normalization factor by searching only upper (N−1-L) bits among (N−1) bits since the address generation unit uses each upper L bits of normalized magnitudes when the table lookup address is generated.

5. The phase calculator as claimed in claim 1, wherein the phase expanding unit performs a phase expansion as indicated in Table 3 below, that is, the resultant phase θ with M bits precision is obtained using the lookuped phase ρ with (M−2) bits precision and the signs of input data.
TABLE 2

| Sign (d_{Ich}) | sign (d_{Qch}) | θ_{M-1} | θ_{M-2} | θ_{M-3} . . . θ₀ |
|---|---|---|---|---|
| 0 | 0 | 0 | 0 | ρ |
| 1 | 0 | 0 | 1 | \overline{ρ} |
| 1 | 1 | 1 | 0 | ρ |
| 0 | 1 | 1 | 1 | \overline{ρ} |

6. The phase calculator as claimed in claim 1 or 5, wherein the phase expanding unit calculates a 2's complement of ρ in a manner that a 1's complement of ρ is produced, and then 1 is added to an LSB through a following operation to perform a high-speed operation.

7. The phase calculator as claimed in claim 1, wherein in the phase expanding means, the sign(d_{Qch}) terminal is connected to the θ[M−1] terminal, the sign(d_{Ich}) terminal and the sign(d_{Qch}) are connected to the θ[M−2] terminal and the carry terminal through the XOR(M−2), and it is determined whether to take a 1's complement of ρ[M−3:0] when a ρ[M−3:0] terminal corresponds to θ[M−3:0] through XOR(M−3) to XOR(M−0) according to an operation result of the XOR(M−2).
